(19) United States
(12) Patent Application Publication
(10) Pub. No.: US 2014/0126226 A1
(43) Pub. Date: May 8, 2014

(54) PORTABLE SEARCHLIGHT HAVING A REPLACEABLE SEALING LAMP COVER FOR WEATHER RESISTANCE

(71) Applicant: Mao-Shen WANG, New Taipei (TW)

(72) Inventor: Mao-Shen WANG, New Taipei (TW)

(21) Appl. No.: 13/670,493

(22) Filed: Nov. 7, 2012

(51) Int. Cl. F21V 31/00

(52) U.S. Cl. 362/375

(57) ABSTRACT

A portable searchlight has a replaceable sealing lamp cover suitably fitted for use in effectively blocking moisture from seeping or flowing into the interior of the portable searchlight for weather resistance, and the portable searchlight therefore can still normally deliver the illumination function in any damp environments.

### BACKGROUND

1. Field of the Invention

The present invention relates to a portable searchlight, and more particularly, to a portable searchlight having a replaceable sealing lamp cover used for weather resistance.

2. Description of Prior Art

A prior art portable searchlight 10 shown in FIG. 1 is a multi-purpose searchlight that can change light projection angles longitudinally and horizontally. The prior art portable searchlight 10 consists of a housing 11, a supporting base 14 pivoted to a bottom of the housing 11, and a set of lamp assemblies 15 pivoted to the housing 11.

The housing 11 consists of an upper housing 12 and a lower housing 13. Apart from being formed with a lamp receiving trough 16 capable of receiving the set of lamp assemblies 15, the housing 11 is also provided with a longitudinal driving device (not shown) and a horizontal driving device (not shown) therein.

After the lamp assemblies 15 is installed inside the lamp receiving trough 16 of the housing 11, the lamp assemblies 15 and the lamp receiving trough 16 are pivoted together and will be driven by the longitudinal driving device inside the housing 11.

Therefore, by manipulating the longitudinal driving device inside the housing 11, the lamp assemblies 15 can be manipulated in the lamp receiving trough 16 to incline upwards or downwards in a vertical direction and to change the light projection angles in a longitudinal direction.

After the housing 11 is installed on the supporting base 14, the housing 11 and the supporting base 14 are also pivoted together. The housing 11 and the lamp assemblies 15 can be driven by the horizontal driving device inside the housing 11 to rotate leftwards or rightwards together with respect to the supporting base 14, and thus the lamp assemblies 15 can change the light projection angles in a horizontal direction.

Therefore, this prior art portable searchlight 10 has the advantage of multi-angular illumination, and can be applied in various applications where illuminating apparatuses are needed. This makes the application scope of the portable searchlight 10 relatively wide.

However, this prior art portable searchlight 10 still has shortcomings in use; and particularly in damp environments where it is liable to influence of the moisture, the shortcoming that it suffers from frequent malfunctions becomes prominent. The reason is that, the housing 11 of this prior art portable searchlight 10 lacks to have a water resistant structure designed for weather resistance. Specifically, in the windy and rainy climates, rain water will seep or flow into the housing 11 along a clearance between the lamp receiving trough 16 of the housing 11 and the lamp assemblies 15; and consequently, malfunctions often occur to the mechanical parts or the electronic parts inside the housing 11 due to the influence of the moisture so that this prior art portable searchlight 10 cannot deliver the illumination function normally.

### SUMMARY OF THE INVENTION

The present invention is to provide a portable searchlight suited for weather resistance comprises a housing provided with a bottom, a supporting base pivoted to the bottom of the housing, a set of lamp assemblies pivoted to the housing and a replaceable sealing lamp cover for fit on the housing, wherein the housing is formed with a lamp receiving trough for the lamp assemblies pivoted therein, and the replaceable sealing lamp cover is fitted on the outside the lamp receiving trough to effectively block moisture from seeping or flowing into the lamp receiving trough of the housing of the portable searchlight.

The portable searchlight of the present invention not only has a multi-angular illumination advantage of changing light projection angles longitudinally and horizontally, but also has a water-resistant function if the replaceable sealing lamp cover is fitted to the housing of the portable searchlight, so that the portable searchlight of the present invention can still normally deliver the illumination function in any damp environments.

### BRIEF DESCRIPTION OF THE DRAWINGS

FIG. 1 is a schematic outline view of a prior art portable remote-controlled searchlight;

FIG. 2 is a schematic outline view of a portable searchlight of the present invention; and

FIG. 3 is an exploded view of the portable searchlight of the present invention.

### DETAILED DESCRIPTION OF THE INVENTION

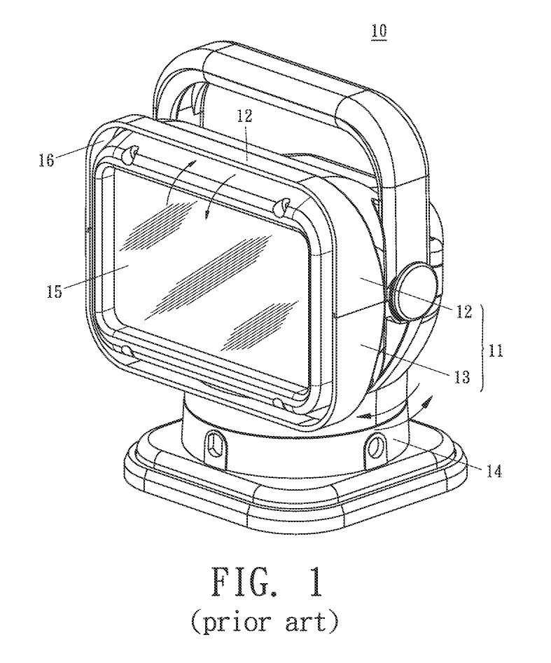

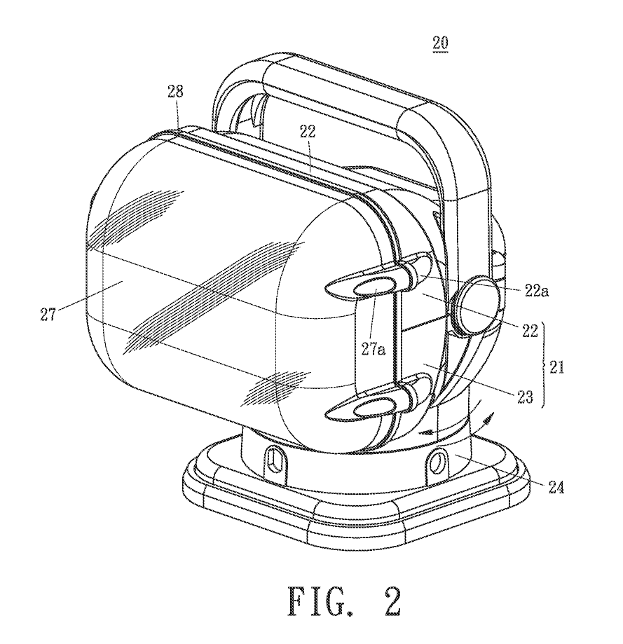

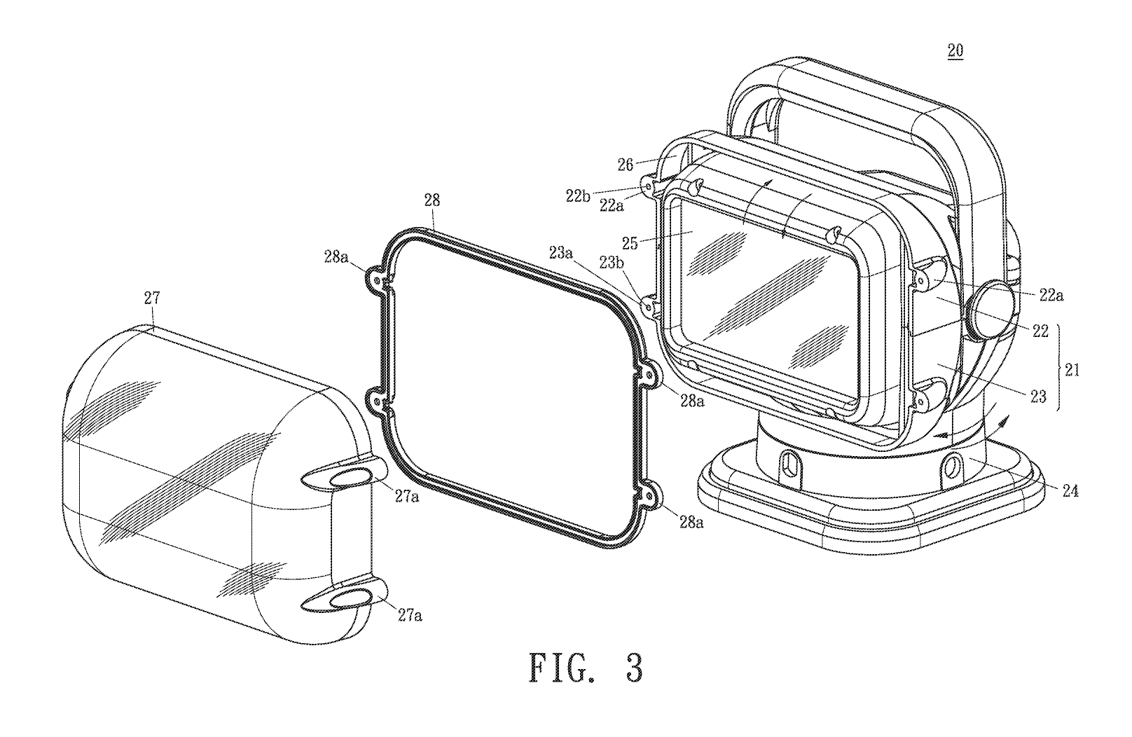

Referring to FIG. 2 and FIG. 3, the general structure of a portable searchlight 20 of the present invention is similar to that of the prior art portable searchlight 10 shown in FIG. 1 except that the portable searchlight 20 is further provided with a replaceable sealing lamp cover 27 for weather resistance. However, through disposition of the replaceable sealing lamp cover 27, the portable searchlight 20 of the present invention can be provided with a water-resistant function which can deliver an effect of blocking moisture from seeping or flowing into a housing 21 of the portable searchlight 20. Thereby, the portable searchlight 20 of the present invention can still normally deliver the illumination function in damp environments.

Therefore, the portable searchlight 20 of the present invention consists of a housing 21, a supporting base 24 pivoted to a bottom of the housing 21, a set of lamp assemblies 25 pivoted to the housing 21, and a replaceable sealing lamp cover 27 closely fitted to the outside of a lamp receiving trough 26 of the housing 21 in which the lamp assemblies 25 are installed.

The set of lamp assemblies 25 is pivoted inside the lamp receiving trough 26 of the housing 21 that is formed by an upper housing 22 and a lower housing 23. By manipulating a longitudinal driving device (not shown) inside the housing 21, the set of lamp assemblies 25 can be driven in the lamp receiving trough 26 to incline upwards or downwards in a vertical direction and to change light projection angles in a longitudinal direction.

Meanwhile, by manipulating a horizontal driving device (not shown) inside the housing 21 after the housing 21 and the supporting base 24 are pivoted together, the housing 21 and the set of lamp assemblies 25 can be driven to rotate leftwards or rightwards together with respect to the supporting base 24. Thereby, the set of lamp assemblies 25 can change light projection angles in a horizontal direction.

The replaceable sealing lamp cover 27 is a transparent shell device made of a transparent material for weather resistance as well as for illumination, and the replaceable sealing lamp cover 27 has a concave notch which profile is consistent with the profile of an opening of the lamp receiving trough 26 of the housing 21. Therefore, the replaceable sealing lamp cover 27 is capable of being joined with the lamp receiving trough 26 of the housing 21 for closely force fit each other through such a convex and concave joining structures.

The replaceable sealing lamp cover 27 if fitted on the lamp receiving trough 26 of the housing 21 of the portable searchlight 20 forms an enclosed space capable of blocking entry of water or moisture, which can effectively block the moisture from seeping or flowing into the housing 21 of the portable searchlight 20. Meanwhile, the lamp assemblies 25 of the portable searchlight 20 can still be able to be inclined upwards or downwards in the vertical direction within the lamp receiving trough 26 so as to change the light projection angles in the longitudinal direction. Therefore, the portable searchlight 20 can normally deliver the illumination function in any environment without being affected by an external damp environment.

The replaceable sealing lamp cover 27 is detachable from the portable searchlight 20, so that a new replaceable sealing lamp cover 27 is capably reinstalled to the portable searchlight if need of repair or maintenance.

Furthermore, a water-resistant gasket 28 is selective to be disposed between the replaceable sealing lamp cover 27 and the lamp receiving trough 26 to enhance an effect of weather resistance to the portable searchlight 20 of the present invention.

In order to enhance the closely joining effect between the replaceable sealing lamp cover 27 and the lamp receiving trough 26, the upper housing 22 and the lower housing 23 of the housing 21 of the portable searchlight 20 is further provided with joining portions 22a and 23a respectively for join with the replaceable sealing lamp cover 27. Each joining portion 22a of the upper housing 22 may be formed as a rib having a threaded hole 22b for a threaded joint or formed as a tenon or a mortise structure for a tenon and mortise joint without any fastening screws. Likewise, each joining portion 23a of the lower housing 23 may be formed as a rib having a threaded hole 23b for a threaded joint or formed as a tenon or a mortise structure for a tenon and mortise joint.

For closely assembly, the replaceable sealing lamp cover 27 has joining blocks 27a corresponding to the constructions of the joining portion 22a and the joining portion 23a for a threaded joint or for a tenon and mortise joint with the joining portion 22a and the joining portion 23a.

The water-resistant gasket 28 is also provided with joining lugs 28a for positioning to the joining portion 22a and the joining portion 23a of the housing 21 of the portable searchlight 20. A fastening screw is taken through the joining block 27a of the replaceable sealing lamp cover 27 and the lug 28a of the water-resistant gasket 28 and finally locked into the threaded hole 22b of each joining portion 22a of the upper housing 22 or the threaded hole 23b of each joining portion 23a of the lower housing 23 respectively, or by closely mating a tenon and mortise joint of the replaceable sealing lamp cover 27 with the joining portion 22a of the upper housing 22 or the joining portions 23a of the lower housing 23, the replaceable sealing lamp cover 27 and the water-resistant gasket 28 are together fitted on the outside the lamp receiving trough 26 of the housing 21 of the portable searchlight 20 to effectively block moisture from seeping or flowing into the lamp receiving trough 16.

Accordingly, the portable searchlight 20 of the present invention has an improved function of weather resistance suitable for use in any environment, and particularly in a damp environment the portable searchlight 20 of the present invention can still normally deliver the multi-angular illumination function of changing light projection angles longitudinally and horizontally.

What is claimed is:

1. A portable searchlight suited for weather resistance, comprising a housing having a bottom, a supporting base pivoted to the bottom of the housing, a set of lamp assemblies pivoted to the housing and a replaceable sealing lamp cover for fit on the housing, wherein the housing is formed with a lamp receiving trough for the lamp assemblies pivoted therein, and the replaceable sealing lamp cover is fitted on the outside the lamp receiving trough to effectively block moisture from seeping or flowing into the lamp receiving trough.

2. The portable searchlight of claim 1, further comprising a water-resistant gasket disposed between the lamp receiving trough of the housing and the replaceable sealing lamp cover.

3. The portable searchlight of claim 1, wherein the housing is formed by an upper housing and a lower housing.

4. The portable searchlight of claim 1, wherein the housing has joining portions and the replaceable sealing lamp cover has joining blocks joined with the joining portions of the housing.

5. The portable searchlight of claim 2, wherein the housing has joining portions, the water-resistant gasket has joining lugs for positioning to the joining portions of the housing and the replaceable sealing lamp cover has joining blocks joined with the joining portions of the housing to have the water-resistant gasket disposed between the housing and the replaceable sealing lamp cover.

6. The portable searchlight of claim 5, wherein each joining portion of the housing has a threaded hole provided for a threaded joint with the corresponding joining block of the replaceable sealing lamp cover through a fastening screw.

7. The portable searchlight of claim 5, wherein each joining portion of the housing is formed as a tenon structure or a mortise structure provided for a tenon and mortise joint with a corresponding mortise structure or a corresponding tenon structure formed on the joining block of the replaceable sealing lamp cover.
